(19) United States
(12) Patent Application Publication
(10) Pub. No.: US 2009/0252204 A1
(43) Pub. Date: Oct. 8, 2009

(54) Receiver system for receiving analog and digital signals

(75) Inventors: Raed S. Shatara, Carmel, IN (US); Matthew J. Yarosz, Kokomo, IN (US)

Correspondence Address: DELPHI TECHNOLOGIES, INC., M/C 480-410-202, PO BOX 5052, TROY, MI, 48007, US

(73) Assignee: DELPHI TECHNOLOGIES, INC., Troy, MI (US)

(21) Appl. No.: 12/080,759

(22) Filed: Apr. 4, 2008

(51) Int. Cl. H04L 27/00; H04B 17/00

(52) U.S. Cl. 375/216; 455/345; 455/277.2

(57) ABSTRACT

A receiver system and method thereof are provided, wherein the receiver system includes a plurality of antenna elements, a receiver device, and a switching system. The antenna elements are configured to receive a signal including first and second antenna elements. The receiver device is in communication with the first and second antenna elements. The switching system switches between the antenna elements using a first switching device, to electrically connect the receiver device when a digital signal is available, and the digital signal received by the first antenna element has a greater signal quality than the digital signal received by other antenna elements. The switching system also switches among the antenna elements to electrically connect the receiver device and the first antenna element to receive the analog signal using a second switching device when the digital signal is unavailable.

### TECHNICAL FIELD

The present invention generally relates to a receiver system, and more particularly, to a receiver system for receiving signals from both analog and digital broadcasts.

### BACKGROUND OF THE DISCLOSURE

Typically, vehicles are equipped with an antenna for receiving radio signals. One example of such an antenna is a mast antenna, which extends from the exterior body of the vehicle. Generally, the mast antenna often interferes with the desired styling of the vehicle, and the mast antenna's protrusion makes it susceptible to damage.

An alternative to the mast antenna is placing the antenna within glass on the vehicle, such as a windshield of the vehicle. Whether the single antenna is a mast antenna, an in-glass antenna, or other type of antenna, a single antenna typically has inherent limitations under certain conditions, such as those with fading and multipath signal interference resulting from an obstruction, which can be caused by the presence of a building, a mountain, or another vehicle. Furthermore, in-glass antennas typically are susceptible to fading and multipath signal interference due to their gain, their directivity, and their polarization properties. There have been several techniques developed using multiple antennas for receiving radio signals to reduce the effects of such fading and interference.

One exemplary technique is scanning/selection or switching diversity. The scanning/selection or switching diversity technique operates on the premise that if one antenna on the vehicle is receiving a poor signal, another antenna spaced from the first antenna may be receiving a better signal. Typically, the system either compares the signals that are being received by the system's multiple antennas to ascertain which antenna is receiving the better quality signal, or the system evaluates the signal being received by a single antenna to determine a quality of the signal and simply switches to another antenna if the current signal is designated as unacceptable. However, the switching transients caused by switching between antennas can be audible under some circumstances, and since only one antenna is typically used at any point in time, the system may provide only marginal improvement during fringe reception when compared to single antenna systems.

The equal-gain combining technique generally combines signals received by the antennas in an antenna array by correcting for the phase differences between antennas, then adding the signals pictorially. No adjustments are made to the signals for any difference in the gains of the input signals because only the phases of the input signals are adjusted for alignment in an equal-gain system. However, it is possible that the signal-to-noise ratio may be less than optimal. For example, if two inputs are combined, and one of those inputs contains mostly noise, the combined signal is likely to be of lower quality than the single non-corrected signal. In such a situation, it would have been ideal to use only the signal from the antenna that was not mostly noise.

Another technique is the maximal-ratio combining technique. In the maximal-ratio combining technique, the input signals are generally adjusted according to the detected phase thereof, the magnitudes of the input signals are adjusted according to the detected phase thereof, and the magnitudes of the input signals are adjusted to yield the maximum signal-to-noise ratio. Thus, a signal that is corrupted with noise does not degrade the overall performance of the system. However, the maximal-ratio combining technique is generally very complex, typically, due to the hardware having multiple receivers plus the combined algorithm for combining the multiple signals. Additionally, the cost of implementing such a system can be prohibitive in some environments.

### SUMMARY OF THE INVENTION

According to one aspect of the present invention, a receiver system is provided that includes a plurality of antenna elements configured to receive a signal based upon a user selection. The plurality of antenna elements include a first antenna element and a second antenna element, wherein the first antenna element is configured to receive an analog signal and a digital signal that include substantially the same data. The receiver system further includes a receiver device in communication with the first and second antenna elements, wherein an output of the receiver device is based upon the signals received by at least one of the first and second antenna elements. The receiver system also includes a switching system for switching between the plurality of antenna elements, such that the first antenna element receives a signal and communicates the data to the receiver device, wherein the switching system switches among the plurality of antenna elements to electrically connect the receiver device and the first antenna element using a first switching device when a digital signal is available based upon the user selection, and the digital signal received by the first antenna element has a greater signal quality than the digital signal being received by other antenna elements of the plurality of antenna elements. The switching system also switches among the plurality of antenna elements to electrically connect the receiver device and the first antenna element to receive the analog signal using a second switching device when the digital signal based upon the user selection is unavailable.

According to another aspect of the present invention, a receiver system is provided that includes a plurality of antenna elements configured to receive a signal based upon a user selection. The plurality of antenna elements include a first antenna element and a second antenna element, wherein the first antenna element is configured to receive an analog signal and a digital signal that include substantially the same data. The receiver system further includes a receiver device in communication with the first and second antenna elements, wherein an output of the receiver device is based upon the signals received by at least one of the first and second antenna elements. The receiver system also includes a switching system for switching between the plurality of antenna elements, such that one of the plurality of antenna elements receives the signal and communicates the data to the receiver device, wherein the switching system includes a digital switching device that switches between the plurality of antenna elements, such that when the first antenna element receives the digital signal based upon the user selection and the digital signal received by the first antenna element has a greater signal-to-noise ratio (SNR) than the digital signal being received by the second antenna, the digital switching device electrically connects the first antenna element to the receiver device. The switching system further includes an analog switching device that switches between the plurality of antenna elements to electrically connect one of the plurality of antenna elements to receive the analog signal when the digital signal is unavailable.

According to yet another aspect of the present invention, a method of receiving a signal based upon a user selection is provided that includes the steps of transmitting an analog signal and a digital signal that include substantially the same data, and providing a plurality of antenna elements configured to receive at least one of the analog and digital signals. The method further includes the steps of receiving one of the analog and digital signals by a first antenna element of the plurality of antenna elements, determining a signal quality of the signal received by the first antenna element, utilizing a first switching technique to switch between the plurality of antenna elements to receive the digital signal based upon a user selection, wherein the digital signal is received by the first antenna element when the signal quality of the digital signal received by the first antenna element is greater than the signal quality of the digital signal received by a second antenna element of the plurality of antenna elements, and utilizing a second switching technique to switch between the plurality of antenna elements to receive the analog signal when the digital signal is unavailable.

These and other features, advantages, and objects of the present invention will be further understood and appreciated by those skilled in the art by reference to the following specification, claims, and appended drawings.

### BRIEF DESCRIPTION OF THE DRAWINGS

The present invention will now be described, by way of example, with reference to the accompanying drawings, in which:

FIG. 1 is a block diagram illustrating a receiver system, in accordance with one embodiment of the present invention;

FIG. 2 is a block diagram illustrating a receiver system, in accordance with one embodiment of the present invention;

FIG. 3A is a flow chart illustrating a portion of a method of receiving a signal based upon a user selection, in accordance with one embodiment of the present invention;

FIG. 3B is a flow chart illustrating another portion of a method of receiving a signal based upon a user selection, in accordance with one embodiment of the present invention; and

FIG. 4 is an environmental view of a receiver system, in accordance with one embodiment of the present invention.

### DESCRIPTION OF PREFERRED EMBODIMENTS

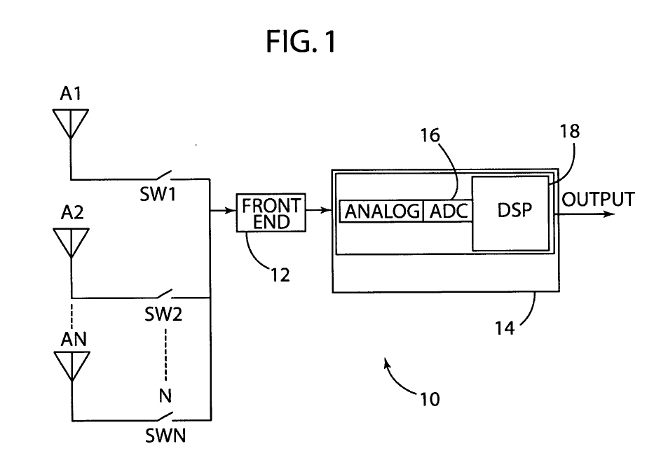

With respect to FIG. 1, an exemplary receiver system is generally shown at reference identifier 10. The receiver system 10 includes a plurality of antenna elements A1,A2 through AN, a receiver front end 12, and a signal processing receiver device 14 having a digital signal processor 18. The receiver device 14 can switch between the antenna elements A1,A2 using a plurality of switches SW1,SW2 through SWN, wherein the switches SW1,SW2 connect the respective antenna element A1,A2 to the receiver front end 12. The signal received by the receiver device 14 is communicated to an analog-to-converter (ADC) 16, and the digital signal can then be processed by the digital signal processor (DSP) 18, to produce an audio output, a video output, or a combination thereof. One exemplary receiver system having a switched antenna arrangement is disclosed in U.S. Patent Application Publication No. 2007/0037538 A1, entitled “TECHNIQUE FOR REDUCING MULTIPATH INTERFERENCE IN AN IN FM RECEIVER,” which the entire disclosure is hereby incorporated herein by reference. It should be appreciated by those skilled in the art that the references herein to first and second antennas A1,A2 are for explanation purposes to describe exemplary embodiments, and are not limiting the invention to two antennas.

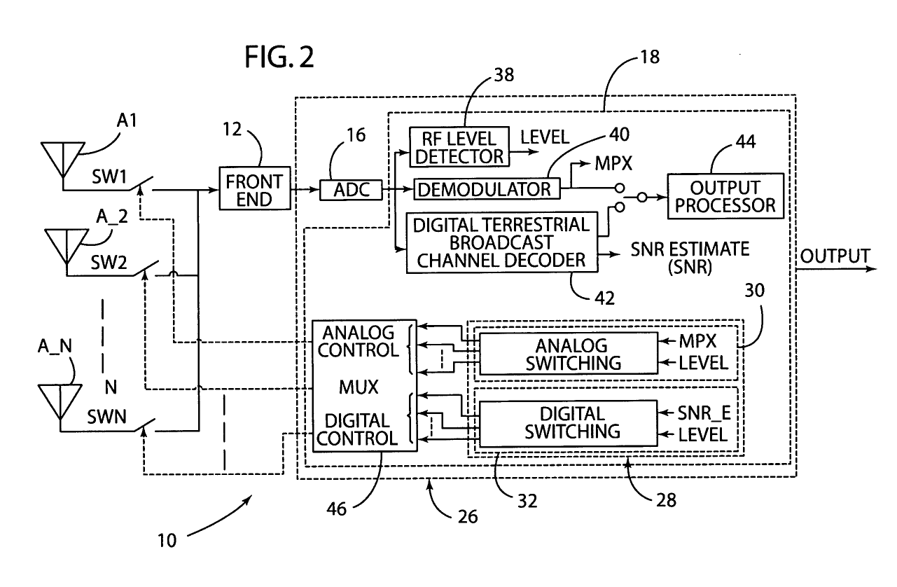

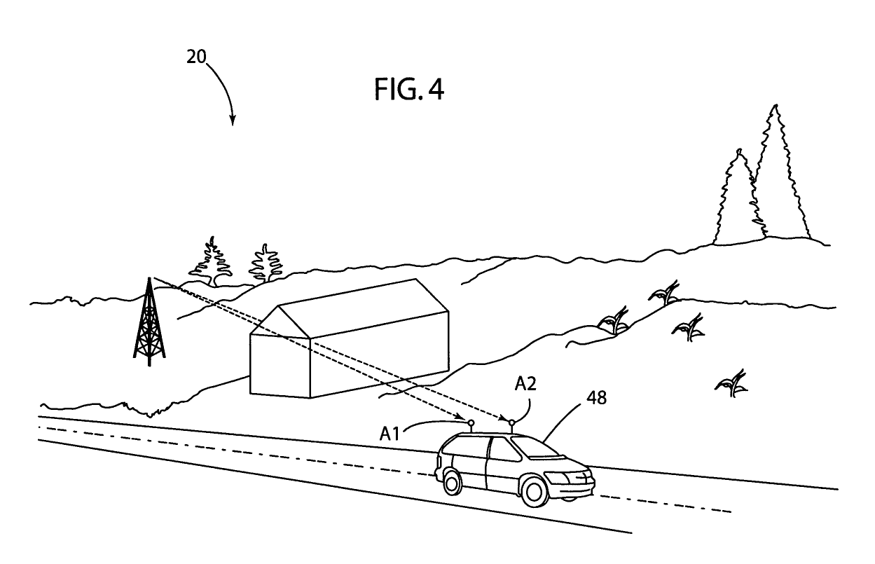

As shown in more detail in FIGS. 2 and 4, according to one embodiment, the receiver system 10 includes a plurality of antenna elements that are configured to receive a signal based upon a user selection, wherein the plurality of antenna elements include a first antenna element A1 and a second antenna element A2, and can continue through antenna element AN. According to one embodiment, the user selection is a user of the receiver system 10 selecting a signal or signals at a frequency or frequency band to be received by at least one of the plurality of antenna elements A1,A2,AN and processed by the receiver system 10. Typically, the first antenna element A1 is configured to receive an analog signal and a digital signal that include substantially the same data. However, it should be appreciated by those skilled in the art that a portion or all of the antenna elements A1,A2,AN can be configured to receive the analog and digital signals. The receiver system 10 further includes a signal processing receiver device generally indicated at 26 in communication with the first and second antenna elements A1,A2, wherein an output of the receiver device 26 is based upon the signals received by at least one of the first and second antenna elements A1,A2.

The receiver system 10 also includes a switching system generally indicated at 28 for switching between the antenna elements A1,A2. Typically, the switching system 28 switches between the plurality of antenna elements A1,A2,AN using a plurality of switches SW1,SW2,SWN, respectively, to connect one of the plurality of antenna elements A1,A2,AN to the receiver device 26 so that the data from the received signal is communicated to the receiver device 26. Thus, the switching system 28 commands the plurality of switches SW1,SW2 to selectively open and close, such that the antenna element A1,A2,AN that is currently electrically connected to the receiver device 14 is the selected antenna element. Typically, the switching system 28 electrically connects the receiver device 26 and the first antenna element A1 when the first antenna element A1 receives the digital signal based upon the user selection and the digital signal received by the first antenna element A1 has a greater signal quality than the signal being received by the second antenna element A2, as described in greater detail herein. For purposes of explanation and not limitation, the signal quality is described herein as a signal-to-noise ratio (SNR). However, it should be appreciated by those skilled in the art that other measurable signal quality characteristics can be used to determine if the signal is being adequately received.

According to one embodiment, the switching system 28 includes an analog switching device 30 that utilizes a first switching technique to receive the analog signal, and a digital switching device 32 that utilizes a second switching technique to receive the digital signal. The switching system 28, analog switching device 30, digital switching device 32, or a combination thereof can be hardware circuitry and/or one or more executable software routines that are configured to control the switches SW1,SW2 to switch between the plurality of antenna elements A1,A2. By way of explanation and not limitation, the switching system 28, analog switching device 30, digital switching device 32, or a combination thereof can be a processor, such as the DSP 18, wherein the DSP 18 executes one or more software routines that are stored in a memory device.

Typically, when the analog signal is received based upon the user selection, the analog switching device 30 controls the switches SW1,SW2 to switch between the plurality of antenna elements A1,A2 to receive the analog signal and to communicate the data from the analog signal to the receiver device 26. The aforementioned U.S. Patent Application Publication No. 2007/0037538 A1 discloses an exemplary analog switching device and method thereof. Similarly, when the digital signal is received based upon the user selection, the digital switching device 32 controls the switches SW1,SW2 to switch between the plurality of antenna elements A1,A2 to receive the digital signal and to communicate the data to the receiver device 26. Thus, the switching system 28 is configured to utilize a first switching device or the digital switching device 32 (e.g., first switching technique) to switch between the antenna elements A1,A2,AN to receive the digital signal, and utilize a second switching device or the analog switching device 30 (e.g., second switching technique) to switch between the antenna elements A1,A2,AN to receive the analog signal, when the digital signal is unavailable.

According to one embodiment, the analog and digital signals received by the selected antenna element A1,A2 are communicated through the receiver front end 12 to the ADC 16. The converted signal from the ADC 16 is then communicated to a radio frequency (RF) level detector 38, a demodulator 40, and a digital terrestrial broadcast channel decoder 42, according to one embodiment. Generally, the RF level detector 38 determines when the input signal exceeds a threshold, as described in greater detail herein. The demodulator 42 can be any suitable demodulator configured to demodulate the received analog signal, the received digital signal, or a combination thereof, according to one embodiment. Typically, the digital terrestrial broadcast decoder 42 is any suitable decoder configured to decode the received digital signal, according to one embodiment.

The output of the demodulator 40 and the digital terrestrial broadcast channel decoder 42 is communicated to an output processor 44, such that the data can be processed to produce an output from the receiver device 26 based upon the signals received by the selected antenna element A1,A2. The output can be an audio output, a video output, or a combination thereof. The digital terrestrial broadcast channel decoder 42 can also determine the SNR of the signal received by the selected antenna element A1,A2. Additionally, the outputs from the RF level detector 38 and the demodulator 40 are received by the analog switching device 30, and the outputs from the RF level detector 38 and digital terrestrial broadcast decoder 42 are received by the digital switching device 32.

Typically, the outputs from the analog switching device 30 and digital switching device 32 are received by a multiplexer 46, which communicates an output to control the plurality of switches SW1,SW2. According to one embodiment, the multiplexer 46 communicates a single output based upon the received outputs of the analog switching device 30 and the digital switching device 32, such that the multiplexer 46 output is communicated to control the switches SW1,SW2.

According to one embodiment, the digital switching device 32 switches between the first and second antenna elements A1,A2 to receive a digital signal when the SNR of the digital signal received by the first antenna element A1 is below a first threshold value. When the SNR of the digital signal received by all of the plurality of antenna elements A1,A2 that are configured to receive the digital signal is below a second threshold value, the analog switching device 30 switches between the plurality of antenna elements A1,A2 to receive the analog signal. Thus, the first threshold value is a value, wherein an acceptable output can be produced based upon the received digital signal, and the second threshold value is determined with respect to an SNR value that would produce an unacceptable output based upon the received digital signal.

By way of explanation and not limitation, the first and second threshold values can be based upon the characteristics of receiving, processing, and emitting an output based upon a digital signal. One exemplary situation is where an audio output is generated based upon the received digital signal, such that either a satisfactory level of data from the digital signal was received to produce an output or an unsatisfactory level of data was received and no output can be produced (i.e., the output is a blank audio and/or video output). This differs from an output based upon an analog signal, wherein the output can include static or other noise when the analog signal is not being adequately received. Thus, the first threshold value can be based upon producing an output using the received digital signal, wherein the output contains an acceptable amount of blank output, and the second threshold value can be based upon producing an output using the received digital signal, wherein the output contains an unacceptable time period of blank audio and/or video output. Therefore, the digital signal is “unavailable” when the SNR of the received digital signal is below the second threshold.

According to one embodiment, the analog switching device 30 switches between the plurality of antenna elements A1,A2 to receive the analog signal when only the analog signal can be received based upon the user selection. Typically, the analog switching device 30 switches between the plurality of antenna elements A1,A2 to receive the analog signal, such that the first antenna element A1 receives the analog signal when the SNR of the analog signal received by the first antenna element A1 is greater than the SNR of the analog signal received by the second antenna element A2. Thus, the receiver system 10 can default to receiving the digital signal when the digital signal is available, such that the emitted output is based upon the received digital signal. However, since digital signals can inherently have a reduced transmission range or distance when compared to the transmission range or distance of analog signals, the receiver system 10 can default to emitting an output based upon the digital signal when the digital signal is available, and emit a signal based upon the analog signal, when the analog signal is available and the digital signal is not available. Therefore, a user can continue to receive the data, even when the user is beyond the transmission range of the digital signal by receiving the analog signal, while the system 20 will automatically emit an output based upon the received digital signal, when the digital signal is available, according to one embodiment.

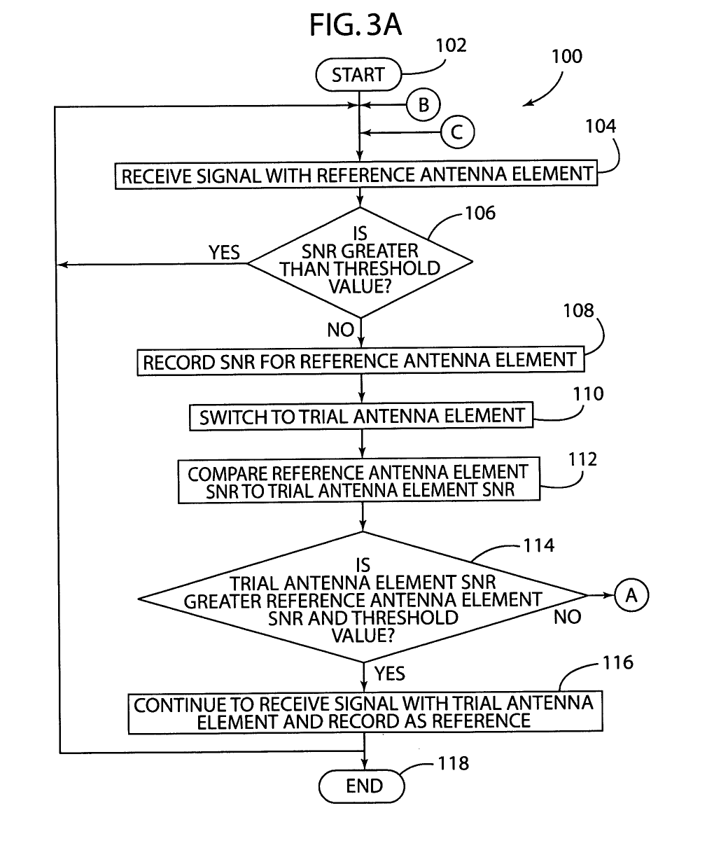

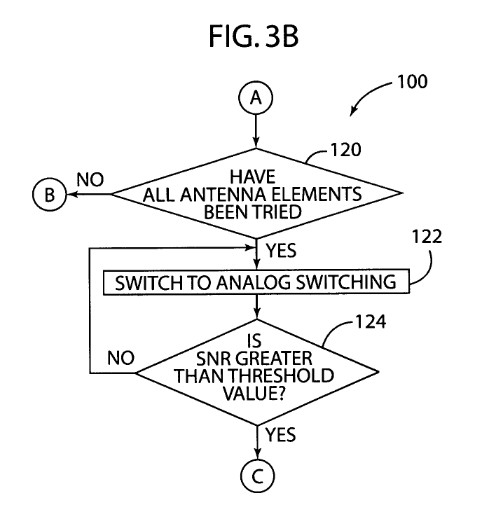

With respect to FIGS. 1-3, a method of receiving a signal based upon a user selection is generally shown in FIG. 3 at 100. The method 100 starts at step 102, and proceeds to step 104, wherein the signal is received with the reference antenna element of the plurality of antenna elements A1,A2,AN. According to one embodiment, the reference antenna element is the first antenna element that is electrically connected to the receiver device 14 by the switching system 28. At decision step 106, it is determined if the SNR of the reference antenna element is greater than a threshold value. If it is determined at decision step 106 that the SNR of the reference antenna element is greater than the threshold value, then the method 100 returns to step 104, such that the reference antenna element is used to receive the digital signal based upon the user selection.

However, if it is determined at decision step 106 that the SNR is not greater than the threshold value, then the method 100 proceeds to step 108, wherein the SNR for the reference antenna element is recorded. At step 110, the switching system 28 switches to a trial antenna element. According to one embodiment, the trial antenna element is any antenna element of the plurality of antenna elements A1,A2,AN other than the antenna element that is currently the reference antenna element. At step 112, the reference antenna element SNR is compared to the trial antenna element SNR.

It is then determined at decision step 114, if the trial antenna element SNR is greater than the reference antenna element SNR and the threshold value. If it is determined at decision step 114 that the trial antenna element SNR is greater than the reference antenna element SNR and the threshold value, then the method 100 proceeds to step 116, wherein the signal is continued to be received with the trial antenna element, and the SNR of the trial antenna element is recorded as the reference antenna element SNR. Thus, the currently selected antenna element adequately receives the digital signal in order to emit an adequate output based upon the user selection, and the method 100 then ends at step 118. However, the method 100 can continue from step 116 by returning to step 104, wherein the signal is received by the reference antenna element.

However, if it is determined at decision step 114 that the trial antenna element SNR is not greater than the reference antenna element SNR and the threshold value, the method 100 proceeds to decision step 120, wherein it is determined if all the antenna elements of the plurality of antenna elements A1,A2,AN have been tried, such that all of the plurality of antenna elements A1,A2,AN have been electrically connected to the receiver device 14 so that the SNR of the connected antenna element (e.g., trial antenna element) is compared to the reference antenna element SNR. If it is determined at decision step 120 that not all of the antenna elements of the plurality of antenna elements have been tried, then the method 100 returns to step 104, wherein the signal continues to be received by the reference antenna element. However, if it is determined at decision step 120 that all of the antenna elements of the plurality of antenna elements have been tried, then the method 100 proceeds to step 122, wherein the switching system switches to using the analog switching device 30. Thus, the analog switching device 30 is now used to switch between the plurality of antenna elements, since it is determined that the digital broadcast is not being emitted based upon the user selection.

At decision step 124, it is determined if the SNR of the received signal is greater than the threshold value. If it is determined at decision step 124 that the SNR is not greater than the threshold value, then the method 100 returns to step 122. However, if it is determined at decision step 124 that the SNR is greater than the threshold value, then the method returns to step 104, wherein the signal continues to be received by the reference antenna element. Thus, the method 100 can continuously switch between the plurality of antenna elements A1,A2,AN utilizing the digital switching device 32 (e.g., first switching technique) and the analog switching device 30 (e.g., second switching technique).

Advantageously, in regards to FIGS. 2-4 the receiver system 10 and method 100 can be used on the vehicle 48 so that as the vehicle 48 is mobile and changes in location with respect to the signal source, the receiver system 10 and method 100 can switch between antenna elements A1,A2 to receive the signal that will produce an acceptable output. Typically, an output based upon a digital signal is either an acceptable output or a non-acceptable output (i.e., an unacceptable period of time containing a blank output), whereas an output based upon an analog signal can be an acceptable output with no static or noise, an acceptable output with static or noise, or an unacceptable output. Thus, it is desirable to receive the digital signal and emit an output based upon the digital signal when the digital signal can be received, but receive the analog signal, which can have a greater transmission range or distance than the digital signal, so that the user can continue to receive the selected content, even when the user is beyond the range of the digital signal without the user needing to enter an additional input after the initial user selection. It should be appreciated by those skilled in the art that additional or alternative advantages can be present in regards to the description herein. It should further be appreciated by those skilled in the art that the above components can be combined in alternative combinations.

The above description is considered that of preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

1. A receiver system comprising:
a plurality of antenna elements configured to receive a signal based upon a user selection comprising:
a first antenna element configured to receive an analog signal and a digital signal that include substantially the same data; and
a second antenna element;
a receiver device in communication with said first and second antenna elements, wherein an output of said receiver device is based upon said signals received by at least one of said first and second antenna elements; and
a switching system for switching between said plurality of antenna elements, such that said first antenna element receives said signal and communicates said data to said receiver device, wherein said switching system switches among said plurality of antenna elements to electrically connect said receiver device and said first antenna element using a first switching device when a digital signal is available based upon said user selection and said digital signal received by said first antenna element has a greater signal quality than said digital signal being received by other antenna elements of said plurality of antenna elements, and switches among said plurality of antenna elements to electrically connect said receiver device and said first antenna element to receive said analog signal using a second switching device when said digital signal based upon said user selection is unavailable.

2. The receiver system of claim 1, wherein said first switching device is a digital switching device and said second switching device is an analog switching device.

3. The receiver system of claim 2, wherein when said analog signal is received based upon said user selection, said analog switching device switches between said plurality of antenna elements to receive said analog signal and to communicate said data to said receiver device.

4. The receiver system of claim 1, wherein said signal quality is based upon a signal-to-noise ratio (SNR) of the received signal.

5. The receiver system of claim 1, wherein said first switching device switches between said first and second antenna elements to receive said digital signal when said signal quality of said digital signal received by said first antenna element is below a first threshold value.

6. The receiver system of claim 1, wherein when said signal quality of said digital signal received by all of said plurality of antenna elements configured to receive said digital signal is below a second threshold value, said second switching device switches between said plurality of antenna elements to receive said analog signal.

7. The receiver system of claim 1, wherein said second switching device switches between said plurality of antenna elements to receive said analog signal when only said analog signal can be received based upon said user selection.

8. The receiver system of claim 1, wherein said second switching device switches between said plurality of antenna elements to receive said analog signal, such that said first antenna element receives said analog signal when said signal quality of said analog signal received by said first antenna element is greater than said signal quality of said analog signal received by said second antenna element.

9. The receiver system of claim 1, wherein said plurality of antenna elements, said receiver device, and said switching system are integrated with a vehicle.

10. A receiver system comprising:
a plurality of antenna elements configured to receive a signal based upon a user selection comprising:
a first antenna element configured to receive an analog signal and a digital signal that include substantially the same data; and
a second antenna element;
a receiver device in communication with said first and second antenna elements, wherein an output of said receiver device is based upon said signals received by at least one of said first and second antenna elements; and
a switching system for switching between said plurality of antenna elements, such that one of said plurality of antenna elements receives said signal and communicates said data to said receiver device, wherein said switching system comprises:
a digital switching device that switches between said plurality of antenna elements, wherein when said first antenna element receives said digital signal based upon said user selection and said digital signal received by said first antenna element has a greater signal-to-noise ratio (SNR) than said digital signal being received by said second antenna, said digital switching device electrically connects said first antenna element to said receiver device; and
an analog switching device that switches between said plurality of antenna elements to electrically connect one of said plurality of antenna elements to receive said analog signal when said digital signal is unavailable.

11. The receiver system of claim 10, wherein when said analog signal is received based upon said user selection, said analog switching device commands a plurality of switches to open and close to switch between said plurality of antenna elements to receive said analog signal and to communicate said analog signal to said receiver device.

12. The receiver system of claim 10, wherein said switching device switches between said first and second antenna elements to receive said digital signal when said SNR of said digital signal received by said first antenna element is below a first threshold value.

13. The receiver system of claim 10, wherein when SNR of said digital signal received by all of said plurality of antenna elements configured to receive said digital signal is below a second threshold value, said switching device switches between said plurality of antenna elements to receive said analog signal.

14. The receiver system of claim 10, wherein said plurality of antenna elements, said receiver device, and said switching device are integrated with a vehicle.

15. The receiver system of claim 10, wherein said switching device switches between said plurality of antenna elements to receive said analog signal, such that said first antenna element receives said analog signal when a radio frequency (RF) level of said analog signal received by said first antenna element is greater than an RF level of said analog signal received by said second antenna element.

16. A method of receiving a signal based upon a user selection, said method comprising the steps of:
transmitting an analog signal and a digital signal that include substantially the same data;
providing a plurality of antenna elements configured to receive at least one of said analog and digital signals;
receiving one of said analog and digital signals by a first antenna element of said plurality of antenna elements;
determining a signal quality of said signal received by said first antenna element;
utilizing a first switching technique to switch between said plurality of antenna elements to receive said digital signal based upon a user selection, wherein said digital signal is received by said first antenna element when said signal quality of said digital signal received by said first antenna element is greater than said signal quality of said digital signal received by a second antenna element of said plurality of antenna elements; and
utilizing a second switching technique to switch between said plurality of antenna elements to receive said analog signal when said digital signal is unavailable.

17. The method of claim 16, wherein said step of utilizing said first switching technique further comprises switching between said plurality of antenna elements to receive said digital signal when said signal quality of said digital signal received by said first antenna element is below a first threshold value.

18. The method of claim 16, wherein said step of utilizing said second switching technique further comprises receiving said analog signal when said signal quality of said digital signal received by all of said plurality of antenna elements configured to receive said digital signal is below a second threshold value.

19. The method of claim 16 further comprising the step of commanding a plurality of switching elements to open and close to switch between said plurality of antenna elements to receive said analog signal when only said analog signal can be received.

20. The method of claim 16, wherein said signal quality is based upon a signal-to-noise ratio (SNR).
